(19) United States
(12) Patent Application Publication
(10) Pub. No.: US 2019/0102319 A1
(43) Pub. Date: Apr. 4, 2019

(54) MEMORY CONTROLLER, MEMORY SYSTEM, INFORMATION PROCESSING SYSTEM, MEMORY CONTROL METHOD, AND PROGRAM

(71) Applicant: SONY CORPORATION, TOKYO (JP)

(72) Inventor: KENICHI NAKANISHI, TOKYO (JP)

(73) Assignee: SONY CORPORATION, TOKYO (JP)

(21) Appl. No.: 16/083,164

(22) PCT Filed: Dec. 28, 2016
(86) PCT No.: PCT/JP2016/089109

§ 371 Date: Sep. 7, 2018

(30) Foreign Application Priority Data
Mar. 16, 2016 (JP) 2016-051836

(51) Int. Cl. G06F 12/121; G06F 13/16; G06F 12/1009; G06F 12/02

(52) U.S. Cl. CPC G06F 12/121; G06F 13/1673; G06F 13/1631; G06F 2212/7203; G06F 12/0246; G06F 2212/7201; G06F 12/1009

(57) ABSTRACT

To reduce a capacity of a buffer included in a memory controller for managing a replacement area of a memory. Replacement management information for managing a relationship between a predetermined data area of a memory and a replacement area corresponding to the data area is stored in the memory. A memory controller includes: a replacement management information buffer configured to hold part of the replacement management information. A replacement processing unit, in a case in which replacement has occurred in the memory for data related to an access command from a host computer to the memory, causes the replacement management information buffer to hold the replacement management information of a portion of the data for which the replacement has occurred.

### TECHNICAL FIELD

The present technology relates to a memory controller. More specifically, the technology relates to a memory controller which manages a relationship between a predetermined data area of a memory and a replacement area corresponding to the data area, a memory system, an information processing system, a processing method therefor, and a program for causing a computer to execute the method.

### BACKGROUND ART

In a case in which it is determined that a page of a memory cell includes a defective cell, a memory controller stops access to the page including the cell thereafter and performs a process of causing another reserved page to be used as a replacement. For example, due to occurrence of an error at the time of a writing operation or occurrence of a bit error at the time a reading operation, a memory cell whose page will not be possible to be continuously used in the future is determined as a defective cell. At this time, since the memory controller has a function of converting a page address instructed from an external host computer into a replacement page address, the memory controller performs a process of replacing the defective page without informing the host computer of the replacement page address. For this reason, the memory controller has a function of maintaining and managing an address conversion table for converting page addresses into replacement page addresses.

In a case of a page for which no replacement is performed, a page address thereof matches a page address input from a host computer. In a case in which a process of replacing the page with a reserved page is performed, the page is registered to be a replacement page address on the address conversion table, and thereby a state in which the host computer can access a normal page at the same page address even after the replacement page is set is maintained. A page address input from the host is also called a logical address and a page address after an address conversion is also called a physical address. In a case in which no replacement occurs, a logical address and a physical address basically have the same value. With regard to a unit size of a replacement process, pages which are reading and writing units are generally replacement units, and in a case in which a certain number of memory cells or more among the pages are determined as defective cells, the cells are managed as being in an unusable state together with other good cells in units of pages.

As an address conversion mechanism for such a replacement process, a defective block management method using a defect mapping table has been proposed (e.g., refer to Patent Literature 1).

### CITATION LIST

### Patent Literature

Patent Literature 1: JP 2006-048893A

### DISCLOSURE OF INVENTION

### Technical Problem

In the above-described related art, in order to realize access using a logical address, it is necessary to hold address conversion table information in a buffer inside a memory controller and to secure a table size equivalent to a logical address space in the buffer. For this reason, there is a problem that, if the logical address space increases, the size of the buffer has to increase accordingly. Meanwhile, although reading only part of the address conversion table necessary for address conversion when the host computer has access by the buffer memory is conceivable, there is then a problem that access performance is degraded due to processes performed to read the address conversion table. Furthermore, since it is necessary for the buffer to read the address conversion table together therewith at the time of activation, there is a problem of a longer activation time.

The present technology has been conceived taking the above-described circumstances into account, and aims to reduce a capacity of a buffer included in a memory controller for managing a replacement area of a memory.

### Solution to Problem

The present technology has been devised to solve the problem above, a first aspect thereof is a memory controller, a memory system, an information processing system, a memory control method thereof, and a program, the memory controller including: a replacement management information buffer configured to hold part of replacement management information for managing a relationship between a predetermined data area of a memory and a replacement area corresponding to the data area in a case in which the replacement management information is stored in the memory; and a replacement processing unit configured, in a case in which replacement has occurred in the memory for data related to an access command from a host computer to the memory, to cause the replacement management information buffer to hold the replacement management information of a portion of the data for which the replacement has occurred. Accordingly, the effect of causing the replacement management information buffer to hold only information necessary for a replacement process can be exhibited.

In addition, according to this first aspect, the replacement processing unit may perform control such that access is made to the memory using an address of the access command in a case in which the replacement has not occurred for the data related to the access command, and performs control such that access is made to the memory using a result obtained by converting the address of the access command into an address of the replacement area in accordance with the replacement management information held by the replacement management information buffer in a case in which the replacement has occurred for the data related to the access command.

In addition, according to this first aspect, the replacement management information buffer may hold, in each data area, an address of the replacement area in the memory which corresponds to the data area. Accordingly, an effect of acquiring a replacement destination address from an address held by the replacement management information buffer can be exhibited.

In addition, according to this first aspect, the replacement management information buffer may hold, in each replacement area, an address of the data area in the memory which corresponds to the replacement area. Accordingly, an effect of acquiring a replacement source address from an address held by the replacement management information buffer can be exhibited.

In this case, a comparison unit configured to generate an address of the replacement area by comparing an address related to the access command with an address held by the replacement management information buffer may be further included. Accordingly, an effect of acquiring a replacement destination address on the basis of an address comparison result can be exhibited.

In addition, according to this first aspect, the replacement management information may manage a relationship between the data area and the replacement area corresponding to the data area in a unit of a page of the memory. The replacement processing unit may determine occurrence or non-occurrence of the replacement in a unit of a section including a plurality of the pages.

In this case, a replacement occurrence flag information buffer configured to hold replacement occurrence flag information representing occurrence or non-occurrence of the replacement for each section may be further included. Accordingly, an effect of detecting occurrence or non-occurrence of replacement for each section can be exhibited.

In this case, the replacement management information buffer may hold the replacement management information related to the plurality of sections. Accordingly, an effect of maintaining replacement management information of a section to which access frequently occurs in the replacement management information buffer can be exhibited.

In this case, the replacement management information buffer may hold the replacement management information with the plurality of consecutive sections as a management unit. Accordingly, an effect of managing the plurality of consecutive sections together can be exhibited.

### Advantageous Effects of Invention

According to the present technology, an excellent effect of reducing a capacity of a buffer included in a memory controller for managing a replacement area of a memory can be exhibited. Note that effects described herein are not necessarily limitative, and any effect that is desired to be described in the present disclosure may be admitted.

### BRIEF DESCRIPTION OF DRAWINGS

FIG. 1 is a diagram illustrating an example of an overall configuration of an information processing system according to a first embodiment of the present technology.

FIG. 2 is a diagram illustrating an example of a storage area of a memory cell array 330 according to the first embodiment of the present technology.

FIG. 3 is a diagram illustrating an example of replacement occurrence flag information according to the first embodiment of the present technology.

FIG. 4 is a diagram illustrating an example of replacement management information according to the first embodiment of the present technology.

FIG. 5 is a flowchart illustrating an example of a processing procedure of a data address conversion process of a replacement processing unit 212 according to the first embodiment of the present technology.

FIG. 6 is a flowchart illustrating an example of a processing procedure of an entry selection process (Step S920) of a replacement management information buffer 240 according to the first embodiment of the present technology.

FIG. 7 is a diagram illustrating an example of an overall configuration of an information processing system according to a second embodiment of the present technology.

FIG. 8 is a diagram illustrating an example of a storage area of a memory cell array 330 according to the second embodiment of the present technology.

FIG. 9 is a diagram illustrating an example of replacement management information according to the second embodiment of the present technology.

FIG. 10 is a diagram illustrating an example of a configuration of an address comparison unit 250 according to the second embodiment of the present technology.

FIG. 11 is a flowchart illustrating an example of a processing procedure of a data address conversion process of a replacement processing unit 212 according to the second embodiment of the present technology.

FIG. 12 is a diagram illustrating an example of a storage area of a memory cell array 330 according to a third embodiment of the present technology.

FIG. 13 is a diagram illustrating an example of replacement management information according to the third embodiment of the present technology.

FIG. 14 is a diagram illustrating an example of a management information area according to the third embodiment of the present technology.

FIG. 15 is a diagram illustrating an example of replacement occurrence flag information according to the third embodiment of the present technology.

FIG. 16 is a flowchart illustrating an example of a processing procedure of a data address conversion process of a replacement processing unit 212 according to the third embodiment of the present technology.

FIG. 17 is a flowchart illustrating an example of a processing procedure of an activation process of a memory system according to the third embodiment of the present technology.

FIG. 18 is a flowchart illustrating an example of a processing procedure of a replacement management information reading process according to the third embodiment of the present technology.

FIG. 19 is a flowchart illustrating an example of a processing procedure of a replacement occurrence flag information reading process (Step S970) according to the third embodiment of the present technology.

FIG. 20 is a flowchart illustrating an example of a processing procedure of a management information address converting process according to the third embodiment of the present technology.

FIG. 21 is a flowchart illustrating an example of a processing procedure of a memory system termination process according to the third embodiment of the present technology.

### MODE(S) FOR CARRYING OUT THE INVENTION

Exemplary embodiments for implementing the present technology (which will be referred to as embodiments below) will be described. Description will be provided in the following order.
1. First embodiment (example in which replacement destination address is held as replacement management information)
2. Second embodiment (example in which replacement source address is held as replacement management information)
3. Third embodiment (example in which a plurality of sections are managed by organized management numbers)

### 1. First Embodiment

### [Configuration of Information Processing System]

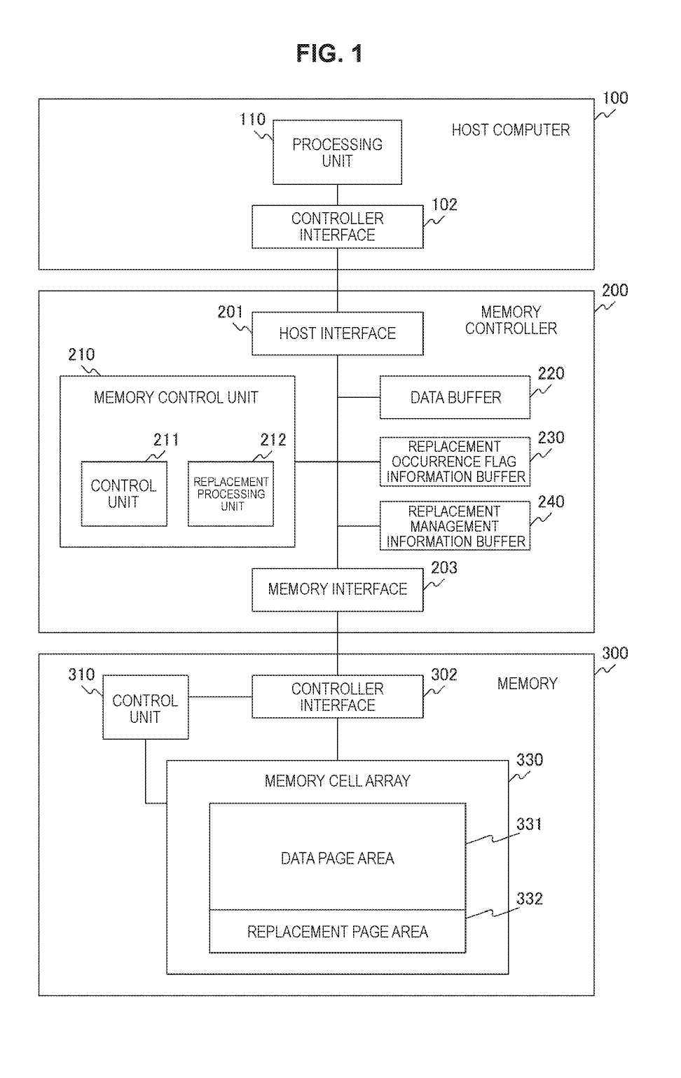

FIG. 1 is a diagram illustrating an example of an overall configuration of an information processing system according to a first embodiment of the present technology. The information processing system includes a host computer 100, a memory controller 200, and a memory 300. The memory controller 200 and the memory 300 are included in a memory system when viewed from the host computer 100.

The host computer 100 issues access commands of reading operations, writing operations, and the like to the memory 300, and includes a processing unit 110 and a controller interface 102. The processing unit 110 is a processor that performs processes necessary for the host computer 100. The controller interface 102 is for interacting with the memory controller 200.

The memory controller 200 controls the memory 300 in accordance with access commands from the host computer 100 to the memory 300. The memory controller 200 includes a memory control unit 210, a data buffer 220, a replacement occurrence flag information buffer 230, a replacement management information buffer 240, a host interface 201, and a memory interface 203.

The memory control unit 210 controls the overall memory controller 200 and includes a control unit 211 and a replacement processing unit 212. The control unit 211 performs general control over the memory controller 200. The replacement processing unit 212 manages a replacement page area 332 of the memory 300 to perform a process of replacing a defective cell occurring on the memory 300 with a good cell. Accordingly, even in a case in which a memory cell array 330 of the memory 300 serving as an access destination has a defective cell, the host computer 100 can access a good cell of a replacement destination by using an address before the occurrence of the defect.

The data buffer 220 is a buffer that temporarily holds data when data transfer is performed between the host computer 100 and the memory 300.

The replacement occurrence flag information buffer 230 holds replacement occurrence flag information representing whether a cell of the memory 300 has been replaced. Detailed content of the replacement occurrence flag information will be described below.

The replacement management information buffer 240 is a buffer that holds replacement management information for converting the address of an access command from the host computer 100 into the address of a replacement destination.

The host interface 201 is for interacting with the host computer 100. The memory interface 203 is for interacting with the memory 300.

The memory 300 includes a control unit 310, the memory cell array 330, and a controller interface 302. The control unit 310 performs control over the memory cell array 330. The controller interface 302 is for interacting with the memory controller 200.

The memory cell array 330 is a memory element in which memory cells storing values are integrated in an array shape. The memory cell array 330 has the replacement page area 332 in which replacement pages are stored in addition to a data page area 331 in which regular data is stored on each page. As the memory cell array 330, a non-volatile memory is assumed. In the non-volatile memory, a defective cell may be generated due to its lifespan, a page including the defective cell may become unusable, and thus in that case, a page of the replacement page area 332 is used as a replacement destination.

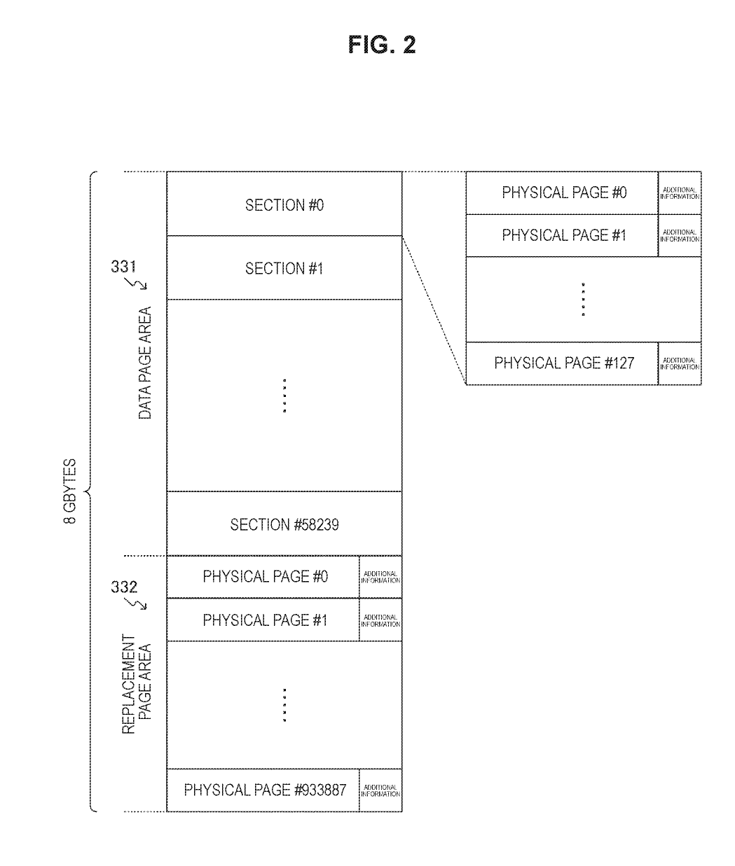

FIG. 2 is a diagram illustrating an example of a storage area of the memory cell array 330 according to the first embodiment of the present technology. In this example, an 8-Gbyte memory space is accessible in units of pages. Each of the pages includes an area having a size of 1 Kbyte for storing data and an area having a size of several bytes for saving additional information. That is, the memory space is accessible in a space size of 8 M pages (8388608 pages) as a whole.

In the first embodiment, the data page area 331 has 7454720 pages in total and is managed by sections each of which is organized to have 128 pages. The data page area 331 includes 58240 sections from section #0 to #58239.

Meanwhile, the replacement page area 332 is used as a replacement destination of the data page area 331 and managed in units of pages. The replacement page area 332 includes 933888 pages from physical page #0 to #933887.

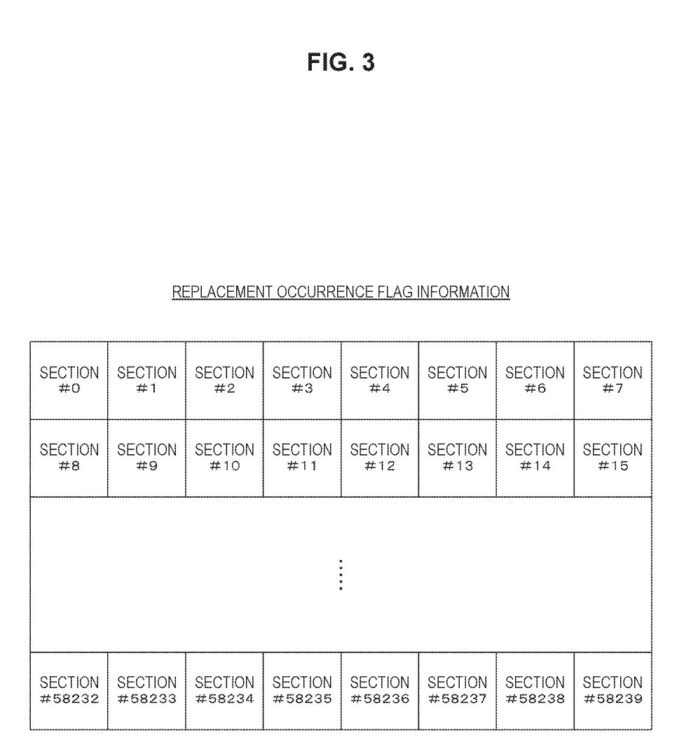

FIG. 3 is a diagram illustrating an example of replacement occurrence flag information according to the first embodiment of the present technology. The replacement occurrence flag information is information representing occurrence or non-occurrence of replacement of defective cells in units of sections. That is, the information represents whether replacement has occurred for the 58240 sections from the section #0 to #58239.

The replacement occurrence flag information is read and held by the replacement occurrence flag information buffer 230 of the memory controller 200 when the memory system is activated. In a case in which replacement has occurred in a section to which a page serving as an access destination of the host computer 100 belongs in accordance with an instruction from the host computer, the replacement management information is necessary for acquiring the address of the replacement destination. The replacement occurrence flag information is information for determining whether the replacement management information is necessary for access. In a case in which 1 bit is set for each section as the replacement occurrence flag information, the overall size of the replacement occurrence flag information is 58240 bits, i.e., 7280 bytes.

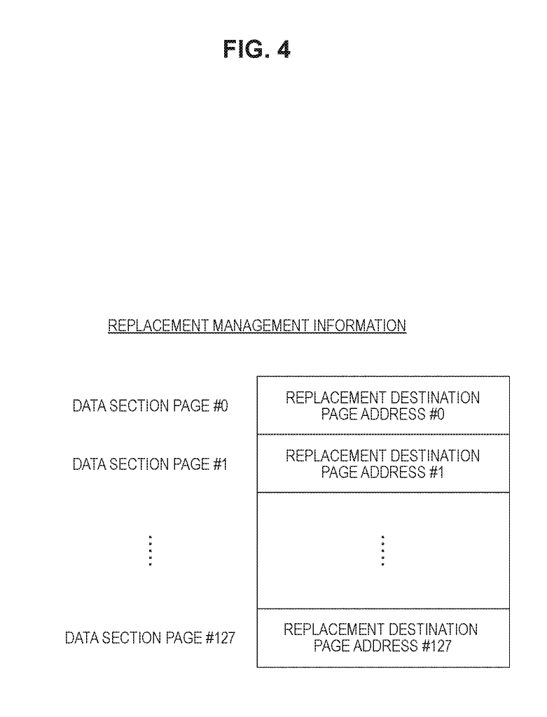

FIG. 4 is a diagram illustrating an example of replacement management information according to the first embodiment of the present technology. In the first embodiment, replacement destination addresses of the replacement page area 332 corresponding to the data page area 331 are held as the replacement management information. That is, in the replacement management information, a page address of the replacement page area 332 serving as a replacement destination is recorded on a page for which replacement has occurred, and fixed data indicating non-occurrence of replacement is recorded on a page for which replacement has not occurred for each of the pages included in a section of the data page area 331. In the first embodiment, by managing the replacement management information for each section, it is possible to hold only replacement management information necessary for access in the replacement management information buffer 240 included in the memory controller 200, and a necessary buffer capacity can be reduced. In the replacement management information buffer 240, one entry is allocated to each section. Although it is desirable to provide a plurality of entries in the replacement management information buffer 240, there is one entry at the minimum. When access is made by the host computer 100, it is determined whether the replacement management information is unnecessary for access to a section for which no replacement occurs on the basis of the replacement occurrence flag information.

In a case in which the replacement management information is not held by the replacement management information buffer 240 when access to a section for which replacement has occurred is made, a time to read the replacement management information is necessary, which leads to a speed reduction. For this reason, reducing the capacity of the replacement management information by managing replacement for each section contributes to improvement in an access speed. In addition, as will be described below, the effect can be further improved by performing control based on a cache algorithm in which replacement management information of a section with a high access frequency is likely to be left in the replacement management information buffer 240.

Bit widths of replacement destination addresses of the replacement management information according to the first embodiment are assumed to each be 20 bits. Thus, the replacement management information of one section in this case is 20 bits×128=320 bytes.

For a page for which no replacement has occurred, fixed data indicating non-occurrence “0xFFFFF” (the numbers following “0x” indicate hexadecimal numbers; the same applies hereinbelow) is set. For a page on which replacement has occurred, a page address of a replacement destination is held as a value other than the fixed data. For the page address of the replacement destination of this case, an offset value from the head of the replacement page area 332 can be used.

### [Operations]

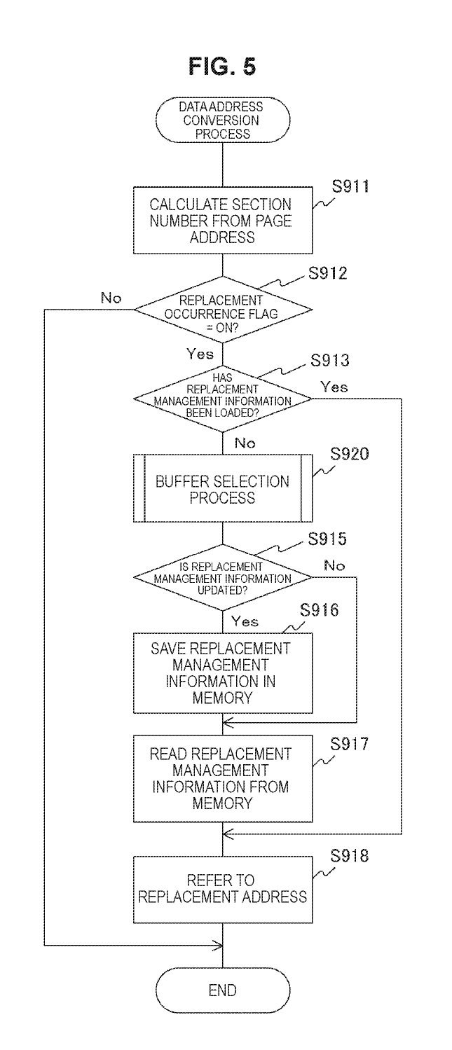

FIG. 5 is a flowchart illustrating an example of a processing procedure of a data address conversion process of the replacement processing unit 212 according to the first embodiment of the present technology.

When the host computer 100 issues an access command, the replacement processing unit 212 calculates a section number from an input page address of the access command (Step S911). Then, the replacement processing unit 212 checks whether replacement has occurred in the section of the section number with reference to the replacement occurrence flag information buffer 230 (Step S912). When no replacement has occurred (No in Step S912), the data address conversion process ends without converting the input page address.

When replacement has occurred in the section (Yes in Step S912), the replacement processing unit 212 determines whether the replacement management information of the section is held by the replacement management information buffer 240 (Step S913). In a case in which the replacement management information of the section has already been held by the replacement management information buffer 240 (Yes in Step S913), the replacement processing unit 212 performs address conversion on the basis of the replacement management information and acquires a page address of a replacement destination (Step S918).

In a case in which the replacement management information of the section is not held by the replacement management information buffer 240 (No in Step S913) first, an entry usable in the replacement management information buffer 240 is selected (Step S920). In a case in which replacement management information held in the selected entry is updated due to additional occurrence of a defective cell (Yes in Step S915), the replacement management information is re-written in a storage area of the memory 300 for the replacement management information (Step S916). Then, replacement management information of the section related to access of this time is read from the storage area of the memory 300 for the replacement management information and held at the selected entry of the replacement management information buffer 240 (Step S917). Accordingly, the replacement processing unit 212 converts the address on the basis of the read replacement management information and acquires the page address of the replacement destination (Step S918).

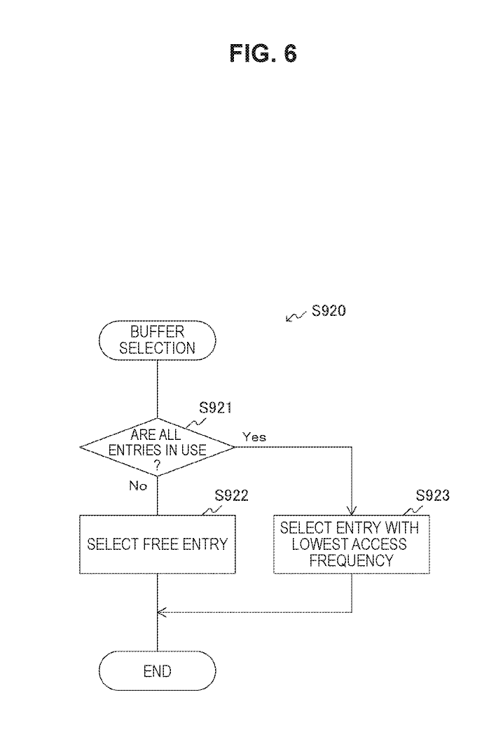

FIG. 6 is a flowchart illustrating an example of a processing procedure of the process of selecting an entry of the replacement management information buffer 240 (Step S920) according to the first embodiment of the present technology.

When not all entries of the replacement management information buffer 240 are in use (No in Step S921), a free entry is selected (Step S922).

On the other hand, when all entries are in use (Yes in Step S921), an entry with a lowest access frequency is selected (Step S923). Accordingly, control is performed such that replacement management information of sections with high access frequencies is left in the replacement management information buffer 240. Since such control based on a cache algorithm is performed, Least Recently Used (LRU) management for a normal cache memory can be applied to the replacement management information buffer 240.

As described above, in the first embodiment of the present technology, by managing the replacement management information held by the replacement management information buffer 240 for each selection, a buffer capacity of the replacement management information buffer 240 can be reduced. Accordingly, memory access speeds can be improved.

### 2. Second Embodiment

In the above-described first embodiment, replacement destination addresses of the replacement page area 332 corresponding to the data page area 331 are held as replacement management information. On the other hand, in a second embodiment, replacement source addresses of the data page area 331 corresponding to the replacement page area 332 are held as replacement management information. Thus, the replacement page area 332 is managed for each section as well.

### [Configuration of Information Processing System]

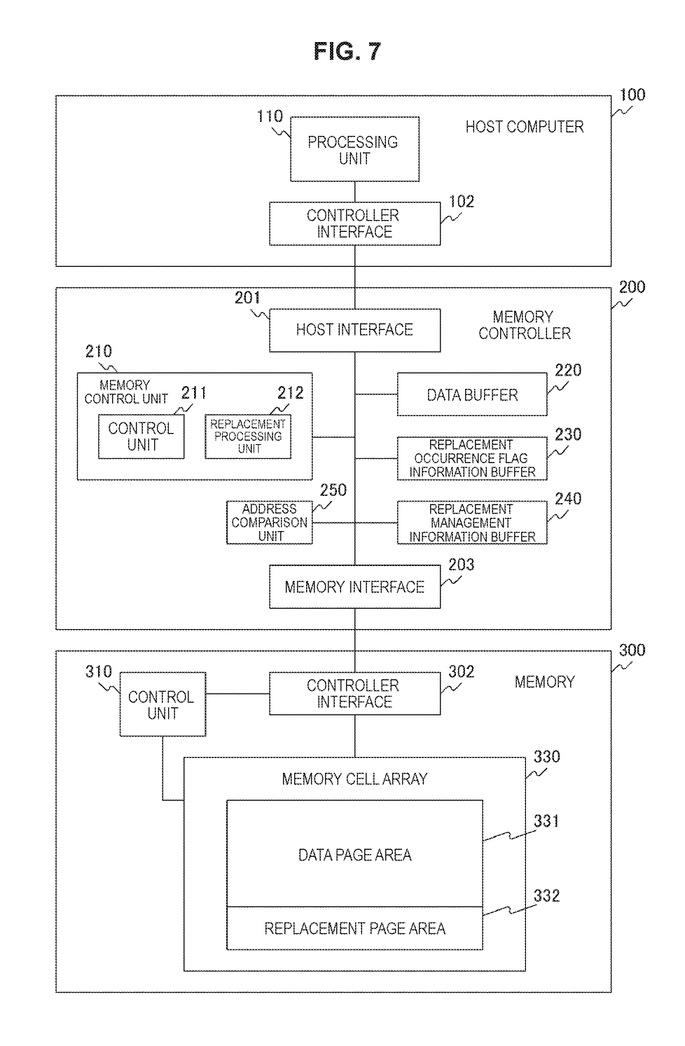

FIG. 7 is a diagram illustrating an example of an overall configuration of an information processing system according to the second embodiment of the present technology. The information processing system according to the second embodiment differs from the first embodiment in that the replacement page area 332 is managed for each section as well. In addition, the second embodiment differs from the first embodiment in that the memory controller 200 includes an address comparison unit 250. In addition, the embodiments differ from each other in that, for the content of the replacement management information, replacement source addresses of the data page area 331 corresponding to the replacement page area 332 are held as described above. The other points are similar to the first embodiment. The second embodiment will be described in detail below focusing on the differences from the first embodiment.

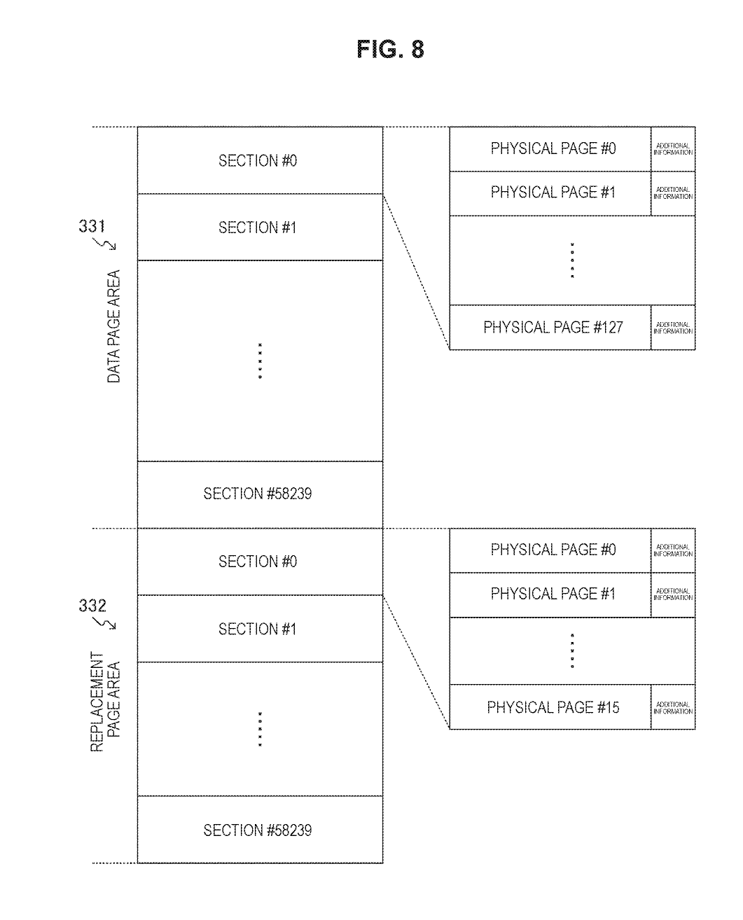

FIG. 8 is a diagram illustrating an example of a storage area of a memory cell array 330 according to the second embodiment of the present technology. In this example, the data page area 331 has 7454720 pages in total and is managed by sections each of which is organized to have 128 pages as in the first embodiment. The data page area 331 includes 58240 sections from a section #0 to #58239.

Meanwhile, the replacement page area 332 used as a replacement destination of the data page area 331 is managed by sections, unlike in the first embodiment. The number of sections of the replacement page area 332 is 58240, which is the same as that of the data page area 331. The number of pages per section of the replacement page area 332 is 16 including physical pages #0 to #15. Therefore, the replacement page area 332 according to the second embodiment has an area of 58240×16=931840 pages.

Bit widths of replacement source addresses of replacement management information of the second embodiment are each assumed to be 8 bits. Thus, replacement management information of one section of this case is 8 bits×16=16 bytes.

For a page for which no replacement has occurred, fixed data indicating non-occurrence “0xFF” is set. In addition, for a page which is not possible to be used as a replacement page due to occurrence of a defect, fixed data “0xFE” is set. In a case in which replacement has occurred, page addresses of the data page area 331 serving as a replacement source are held as values other than the fixed data. For the page address of the replacement source of this case, an offset value from the head of the data page area 331 (from 0 to 127) can be used.

In the second embodiment, since the replacement page area 332 is managed by sections as well, the data page area 331 and the replacement page area 332 can be readily managed in one-to-one correspondence. That is, by fixing a replacement page allocated to a section S of the data page area 331 to a section S of the replacement page area 332, it is unnecessary to hold replacement page addresses in the replacement management information. A head page address of the section S of the replacement page area 332 can be calculated using the following formula.

Head page address of section S=128×58240+16×S

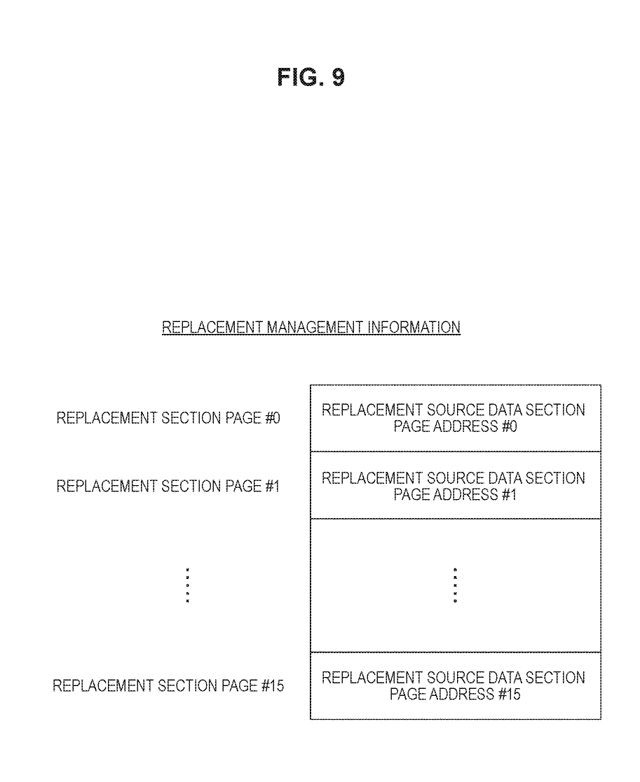

FIG. 9 is a diagram illustrating an example of replacement management information according to the second embodiment of the present technology. In the second embodiment, replacement source addresses of the data page area 331 corresponding to the replacement page area 332 are held as replacement management information. That is, in a case in which replacement has occurred for 16 replacement pages of a certain section, page addresses of a data area serving as a replacement source are stored, and in cases in which a replacement page is defective or a page has not been used as a replacement, fixed values are allocated respectively.

Accordingly, in comparison to the first embodiment, a size of replacement management information can be reduced and replacement management information of more sections can be held with a smaller buffer capacity. In the second embodiment, a size of replacement management information of one section is 16 bytes, and management information of 64 sections can be stored in 1 Kbyte.

Note that replacement occurrence flag information of the second embodiment is similar to that of the above-described first embodiment.

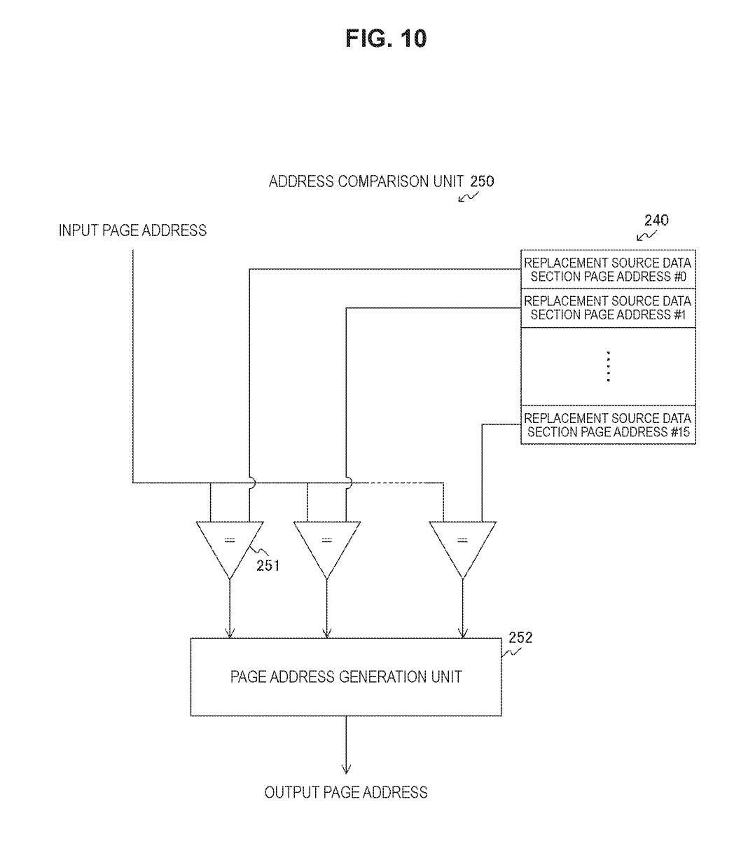

FIG. 10 is a diagram illustrating an example of a configuration of the address comparison unit 250 according to the second embodiment of the present technology. The address comparison unit 250 compares page addresses of access destinations input from the host computer 100 with replacement source page addresses stored for each replacement page, and, in a case in which there are matching addresses, outputs the replacement destination page addresses on the assumption that replacement has been completed. In the other cases, replacement source page addresses are output on the assumption that replacement has not occurred. The address comparison unit 250 has 16 comparators 251 and a page address generation unit 252.

The comparators 251 are each provided to correspond to page addresses of the replacement management information buffer 240, and compare the page addresses with access destination page addresses input from the host computer 100. In a case in which matching is detected, it is assumed that replacement has occurred at the page addresses.

The page address generation unit 252 generates page addresses of physical pages serving as access targets of the memory 300. In a case in which matching is detected at any of the comparators 251, a page address of a page of the replacement page area 332 corresponding to the comparator 251 is output. In a case in which no matching is detected at any comparator 251, an input page address is output without change.

### [Operation]

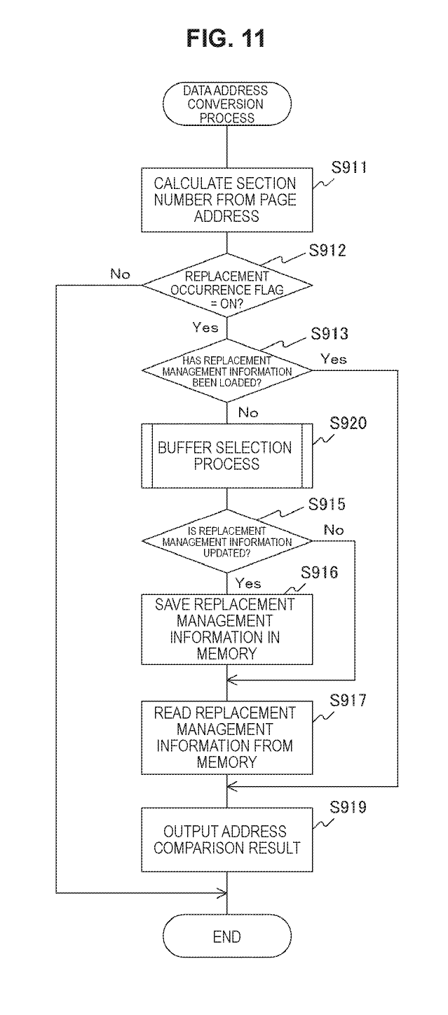

FIG. 11 is a flowchart illustrating an example of a processing procedure of a data address conversion process of the replacement processing unit 212 according to the second embodiment of the present technology

Basically, the data address conversion process according to the second embodiment is substantially similar to that of the first embodiment. Although the page address of the replacement destination is acquired with reference to the replacement management information in Step S918 in the first embodiment, a page address is output using a comparison result of the address comparison unit 250 in the second embodiment (Step S919).

As described above, in the second embodiment of the present technology, by managing the replacement page area 332 by each of the sections, a buffer capacity of the replacement management information buffer 240 can be further reduced. Accordingly, memory access speeds can be further improved than they are in the first embodiment.

### 3. Third Embodiment

In the above-described first and second embodiments, replacement management is performed in units of sections. On the other hand, in a third embodiment, a plurality of consecutive sections are held together in the replacement management information buffer 240. Thus, in the third embodiment, a plurality of consecutive sections are managed by assigning management numbers thereto.

### [Configuration of Information Processing System]

An overall configuration of an information processing system according to the third embodiment is substantially similar to that of the above-described second embodiment. The former differs in that the replacement management information buffer 240 holds a plurality of consecutive sections together, but is similar to the second embodiment in the other points. Thus, detailed description of the overall configuration will be omitted.

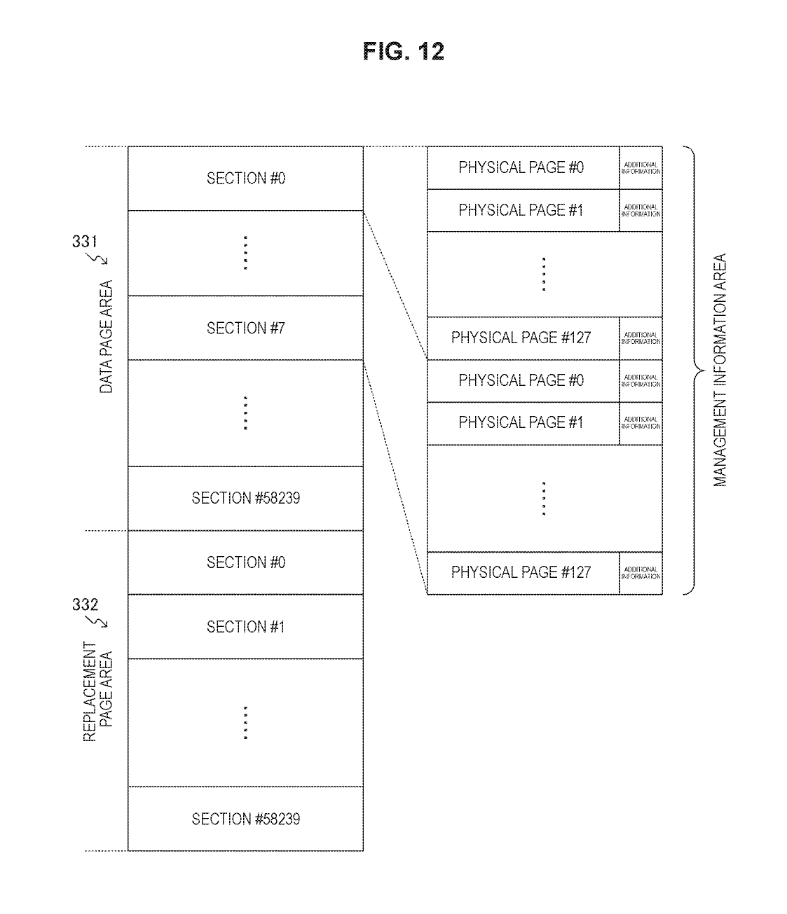

FIG. 12 is a diagram illustrating an example of a storage area of a memory cell array 330 according to the third embodiment of the present technology. In this example, a case in which replacement occurrence flag information and replacement management information are saved in a part of the data page area 331 of the memory 300 is assumed, and 8 consecutive sections from the head of the data page area 331 are used as a management information area.

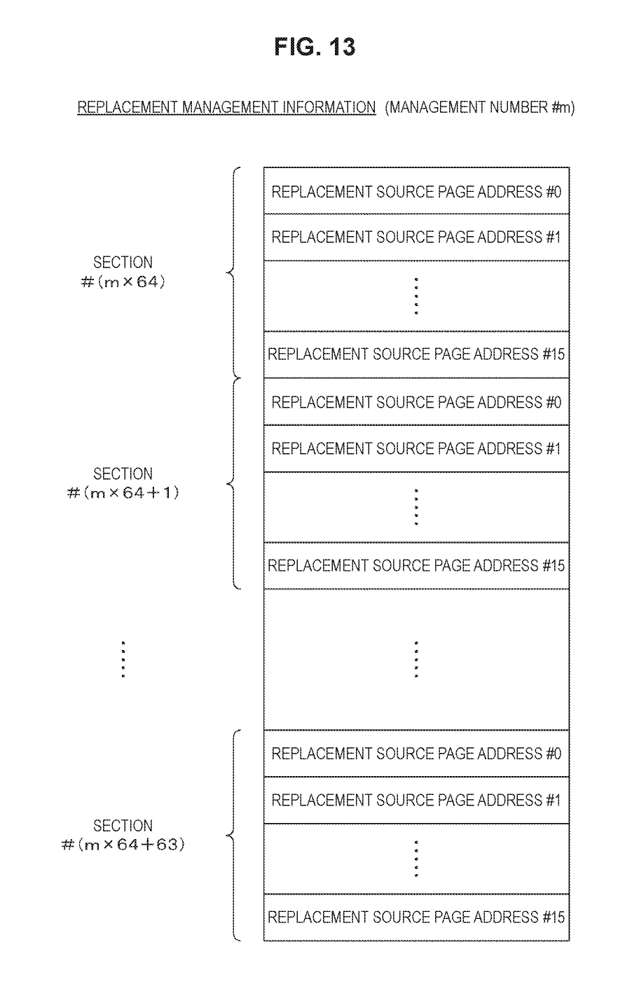

FIG. 13 is a diagram illustrating an example of replacement management information according to the third embodiment of the present technology. In the third embodiment, the replacement management information is managed by allocating management numbers to every 64 consecutive sections and storing the replacement management information with the same management number in one page. That is, it can be ascertained that a size of replacement management information per section is 8 bits×16 pages=16 bytes, and a size of replacement management information per management number is 16 bytes×64 sections=1 Kbyte, which is stored in one page.

The same drawing illustrates the replacement management information with a management number #m. That is, 64 consecutive sections from a section # (m×64) to a section # (m×64+63) are stored in one page.

The memory controller 200 performs acquisition and re-writing operations of the replacement management information in units of pages for each management number with the memory 300. The section number of a certain page corresponds to the quotient obtained by dividing the page address by 128, and the management number corresponds to the quotient obtained by dividing the section number by 64.

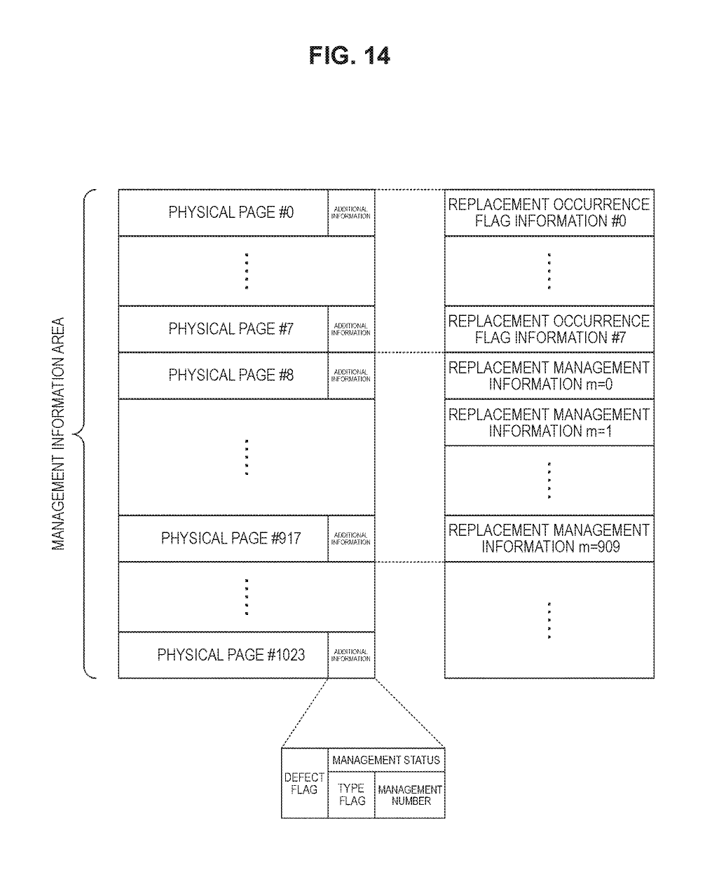

FIG. 14 is a diagram illustrating an example of a management information area according to the third embodiment of the present technology. The 8 pages in the head are a storage area of replacement occurrence flag information, and the 9^{th} page and the following ones save replacement management information with management numbers 0 to 909 in units of pages in an ascending order as a storage area of the replacement management information. Additional information presented on each page includes a defect flag indicating whether the page is normal or defective and a management status. The management status includes a type flag indicating whether information of the page is replacement occurrence flag information or replacement management information in a case in which the information is in the management information area. In addition, in a case in which the information is replacement management information, the management status may include a management number.

In this example, it is assumed that the defect flag is a 1-bit flag and the management status has a 12-bit width. In a case of replacement occurrence flag information, the management status is denoted by “0b01000000XXXX” (the numbers following “0b” mean binary numbers; the same applied hereinbelow). Here, the portion “XXXX” can be a value of “0x0” to “0x8.” In addition, in a case of replacement management information, the management status is denoted by “0b10YYYYYYYYYY.” Here, the portion “YYYYYYYYYY” indicates a management number of “0” to “909.” Note that the management status of an unused state can be “0b000000000000.”

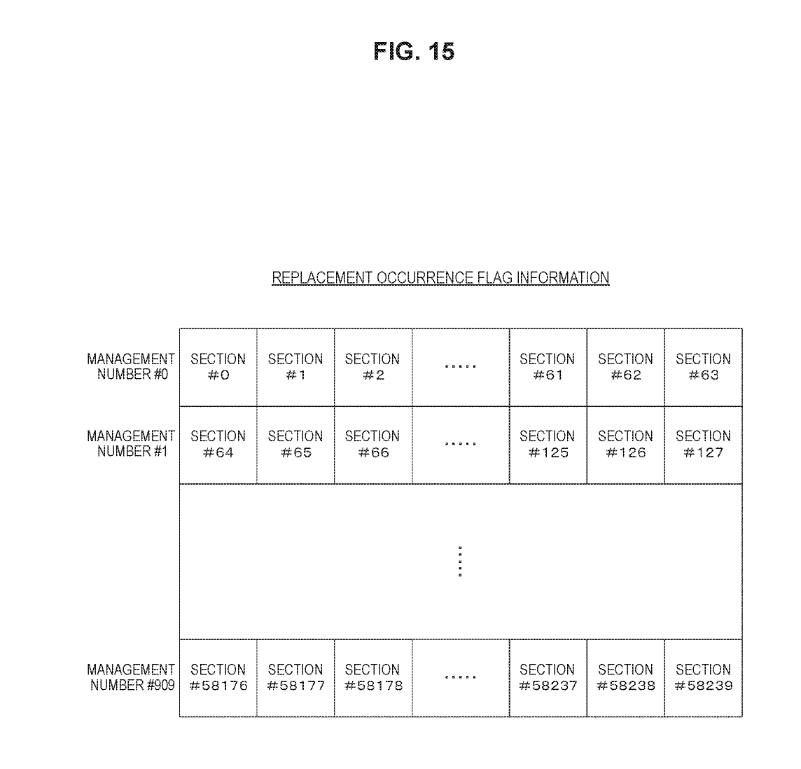

FIG. 15 is a diagram illustrating an example of replacement occurrence flag information according to the third embodiment of the present technology. The replacement occurrence flag information represents occurrence or non-occurrence of replacement of a defective cell in units of sections as in the above-described first embodiment, representing whether replacement has occurred with respect to 58240 sections from a section #0 to #58239.

In the third embodiment, one management number is assigned to every 64 consecutive sections, and the replacement occurrence flag information is managed with a total of 910 management numbers from a management number #0 to #909. An overall size of the replacement occurrence flag information is similar to that of the first embodiment.

### [Operation]

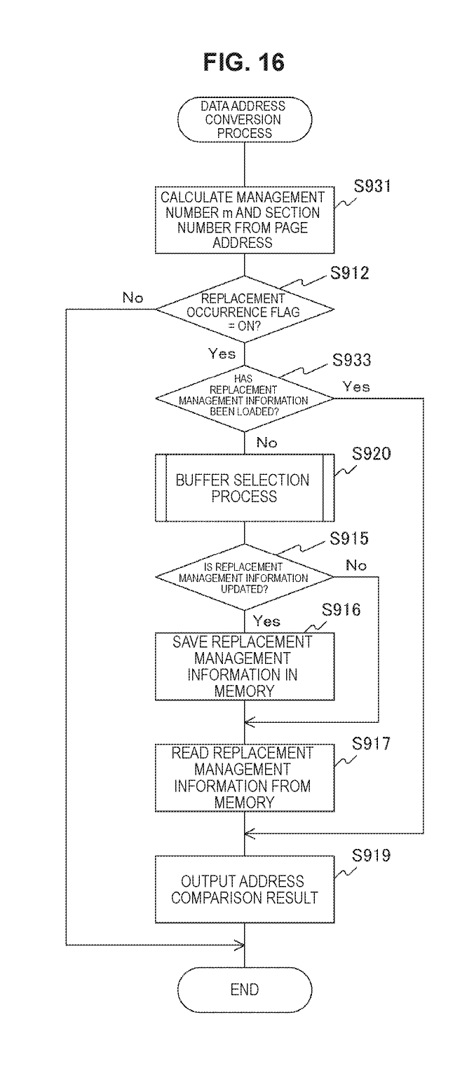

FIG. 16 is a flowchart illustrating an example of a processing procedure of a data address conversion process of the replacement processing unit 212 according to the third embodiment of the present technology.

Basically, the data address conversion process according to the third embodiment is substantially similar to the second embodiment.

When the host computer 100 issues an access command, the replacement processing unit 212 calculates a management number #m and a section number from the page address to which the access command is input (Step S931). Then, the replacement processing unit 212 checks whether replacement has occurred in the section with reference to the replacement occurrence flag information buffer 230 (Step S912). If no replacement occurs (No in Step S912), the data address conversion process ends without converting the input page address.

If replacement occurs in the section (Yes in Step S912), the replacement processing unit 212 determines whether replacement management information of the section is held by the replacement management information buffer 240 in units of management numbers (Step S933). In a case in which the replacement management information of the section has already been held by the replacement management information buffer 240 (Yes in Step S933), the replacement processing unit 212 causes the address comparison unit 250 to determine whether replacement is completed in units of sections. Then, the page address is output using the comparison result (Step S919).

Accordingly, the replacement management information can be held by the replacement management information buffer 240 in units of management numbers. In addition, the replacement management information corresponding to the plurality of management numbers can be held by the replacement management information buffer 240, and the replacement management information can be switched in accordance with access frequencies.

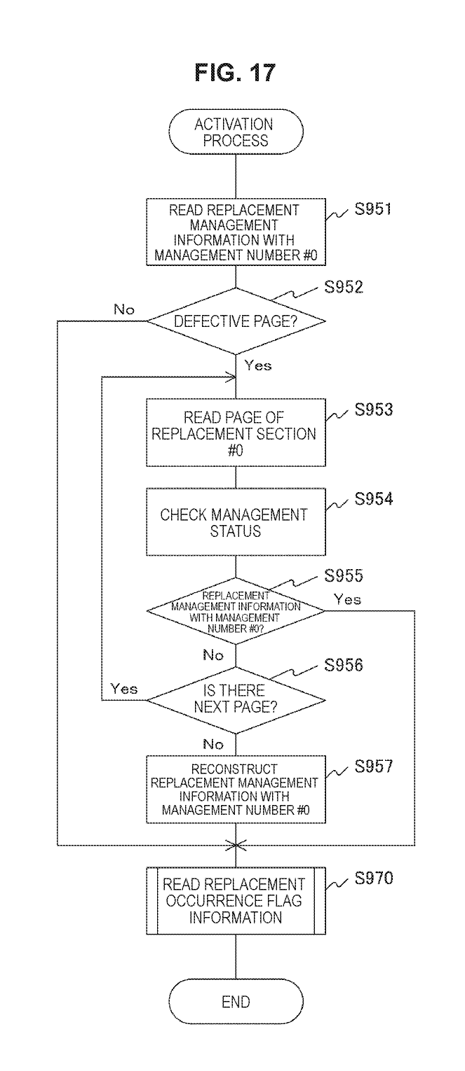

FIG. 17 is a flowchart illustrating an example of a processing procedure of an activation process of a memory system according to the third embodiment of the present technology.

First, replacement management information with a management number #0 necessary for access to a management information area is searched, read from the memory 300, and held by the replacement management information buffer 240 (Step S951). Then, if there is no defective page with reference to the replacement management information (No in Step S952), replacement occurrence flag information is read from the memory 300 to the replacement occurrence flag information buffer 230, and then the process ends (Step S970).

In a case in which there is a defective page (Yes in Step S952), a replacement page of the replacement page area 332 is read (Step S953), and a management status thereof is checked (Step S954). At this time, in a case in which the management status is replacement management information with the management number #0 (Yes in Step S955), replacement occurrence flag information is read from the memory 300 to the replacement occurrence flag information buffer 230, and the process ends (Step S970).

In a case in which the management status is not the replacement management information with the management number #0 (No in Step S955), the processes from Step S953 are repeated on the next page if there is a next page (Yes in Step S956). If there is no next page (No in Step S956), the replacement management information with the management number #0 is reconstructed (Step S957), then the replacement occurrence flag information is read from the memory 300 to the replacement occurrence flag information buffer 230, and then the process ends (Step S970).

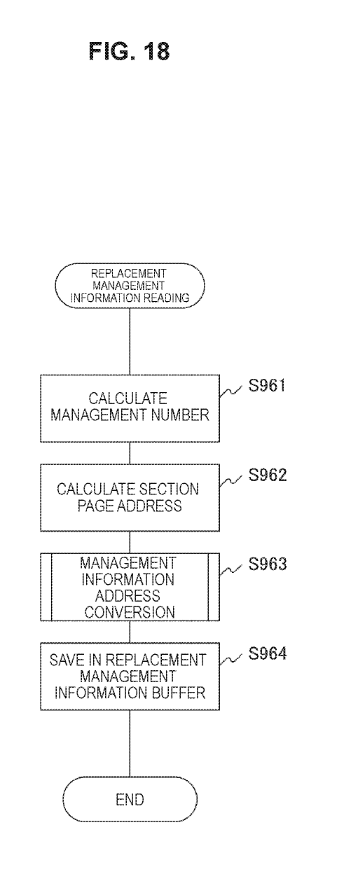

FIG. 18 is a flowchart illustrating an example of a processing procedure of a replacement management information reading process according to the third embodiment of the present technology

The replacement processing unit 212 calculates management numbers from section numbers (Step S961). In addition, the replacement processing unit 212 calculates the page address included in the management information area (Step S962). Then, the replacement processing unit 212 performs address conversion using the replacement management information (Step S963). The replacement management information is read by the replacement management information buffer 240 (Step S964).

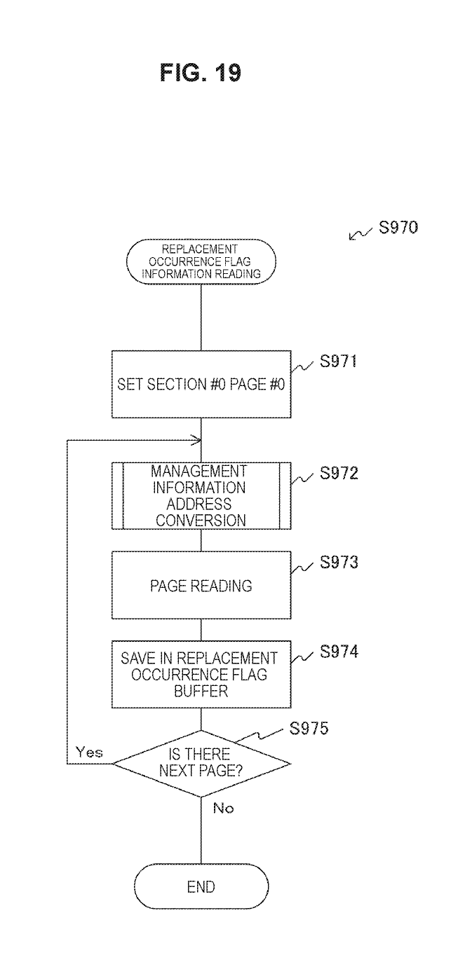

FIG. 19 is a flowchart illustrating an example of a processing procedure of the replacement occurrence flag information reading process (Step S970) according to the third embodiment of the present technology.

The replacement processing unit 212 sets a page #0 of a section #0 first (Step S971), and causes the replacement occurrence flag information saved on all the 8 pages to be held by the replacement occurrence flag information buffer 230 sequentially. Thus, in a case in which replacement has occurred also in an area in which the replacement occurrence flag information is stored, the replacement processing unit 212 performs address conversion using the replacement management information with the management number #0 (Step S972). Then the corresponding page is read (Step S973) and held by the replacement occurrence flag information buffer 230 (Step S974). The replacement processing unit 212 repeats this process for the 8 pages (Step S975).

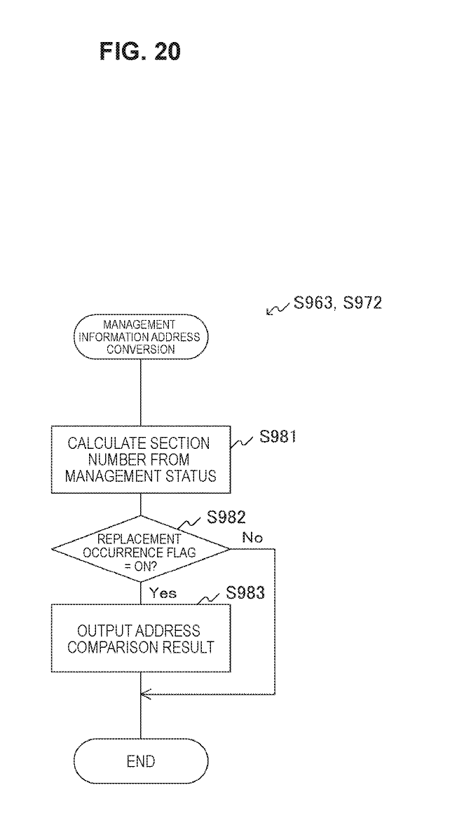

FIG. 20 is a flowchart illustrating an example of a processing procedure of a management information address converting process according to the third embodiment of the present technology. The management information address converting process is a process executed from the above-described Steps S963 and S972. Since a defective cell can exist also in the management information area, in that case, replacement is performed in units of pages using the replacement management information, similarly to normal data of the data page area 331.

The replacement processing unit 212 calculates a section number from a management status (Step S981). A page address that is a saving destination of the management information area can be calculated from a management number. That is, the result obtained by adding “8” to the management number is the page address. The entire management information area is within the range of the management number #0, and the replacement management information with the management number #0 is read from the memory 300 in an activation process and held by the replacement management information buffer 240, and thus access can be made to the data of the entire management information area.

If replacement occurs in the section (Yes in Step S982), the replacement processing unit 212 outputs the page address using the comparison result of the address comparison unit 250 (Step S983).

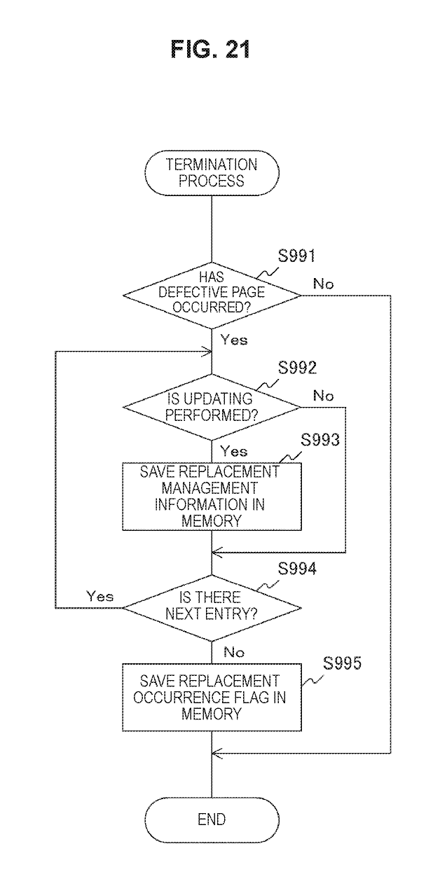

FIG. 21 is a flowchart illustrating an example of a processing procedure of a memory system termination process according to the third embodiment of the present technology. In the memory system, the following termination process is performed before power is turned off.

The replacement processing unit 212 terminates the process without updating of the management information area because updating thereof is unnecessary if no defective page is newly generated during an operation of the memory system with reference to the replacement occurrence flag information (No in Step S991). In a case in which a defective page is generated (Yes in Step S991) and the replacement management information is updated (Yes in Step S992), the replacement processing unit 212 re-writes the replacement management information held by the replacement management information buffer 240 into the memory 300 (Step S993). This process is performed for each entry of the replacement management information buffer 240 (Step S994). Then, the replacement processing unit 212 re-writes the replacement occurrence flag information held by the replacement occurrence flag information buffer 230 into the memory 300 (Step S995).

As described above, according to the third embodiment of the present technology, by managing the replacement management information using the management numbers, replacement management information can be efficiently managed with the replacement management information on one page.

The above-described embodiments are examples for embodying the present technology, and matters in the embodiments each have a corresponding relationship with disclosure-specific matters in the claims. Likewise, the matters in the embodiments and the disclosure-specific matters in the claims denoted by the same names have a corresponding relationship with each other. However, the present technology is not limited to the embodiments, and various modifications of the embodiments may be embodied in the scope of the present technology without departing from the spirit of the present technology.

The processing sequences that are described in the embodiments described above may be handled as a method having a series of sequences or may be handled as a program for causing a computer to execute the series of sequences and recording medium storing the program. As the recording medium, a CD (Compact Disc), an MD (MiniDisc), and a DVD (Digital Versatile Disc), a memory card, and a Blu-ray disc® can be used.

Note that the effects described in the present specification are not necessarily limited, and any effect described in the present disclosure may be exhibited.

Additionally, the present technology may also be configured as below.
(1)

A memory controller including:

a replacement management information buffer configured to hold part of replacement management information for managing a relationship between a predetermined data area of a memory and a replacement area corresponding to the data area in a case in which the replacement management information is stored in the memory; and

a replacement processing unit configured, in a case in which replacement has occurred in the memory for data related to an access command from a host computer to the memory, to cause the replacement management information buffer to hold the replacement management information of a portion of the data for which the replacement has occurred.
(2)

The memory controller according to (1), in which the replacement processing unit performs control such that access is made to the memory using an address of the access command in a case in which the replacement has not occurred for the data related to the access command, and performs control such that access is made to the memory using a result obtained by converting the address of the access command into an address of the replacement area in accordance with the replacement management information held by the replacement management information buffer in a case in which the replacement has occurred for the data related to the access command.
(3)

The memory controller according to (1) or (2), in which the replacement management information buffer holds, in each data area, an address of the replacement area in the memory which corresponds to the data area.
(4)

The memory controller according to any of (1) to (3), in which the replacement management information buffer holds, in each replacement area, an address of the data area in the memory which corresponds to the replacement area.
(5)

The memory controller according to (4), further including:

a comparison unit configured to generate an address of the replacement area by comparing an address related to the access command with an address held by the replacement management information buffer.
(6)

The memory controller according to any of (1) to (5),

in which the replacement management information manages a relationship between the data area and the replacement area corresponding to the data area in a unit of a page of the memory, and

the replacement processing unit determines occurrence or non-occurrence of the replacement in a unit of a section including a plurality of the pages.
(7)

The memory controller according to (6), further including:

a replacement occurrence flag information buffer configured to hold replacement occurrence flag information representing occurrence or non-occurrence of the replacement for each section.
(8)

The memory controller according to (6), in which the replacement management information buffer holds the replacement management information related to the plurality of sections.
(9)

The memory controller according to (6), in which the replacement management information buffer holds the replacement management information with the plurality of consecutive sections as a management unit.
(10)

A memory system including:

a memory;

a replacement management information buffer configured to hold part of replacement management information for managing a relationship between a predetermined data area of the memory and a replacement area corresponding to the data area in a case in which the replacement management information is stored in the memory; and

a replacement processing unit configured, in a case in which replacement has occurred in the memory for data related to an access command from a host computer to the memory, to cause the replacement management information buffer to hold the replacement management information of a portion of the data for which the replacement has occurred.
(11)

An information processing system including:

a memory;

a host computer configured to issue an access command to the memory;

a replacement management information buffer configured to hold part of replacement management information for managing a relationship between a predetermined data area of the memory and a replacement area corresponding to the data area in a case in which the replacement management information is stored in the memory; and

a replacement processing unit configured, in a case in which replacement has occurred in the memory for data related to an access command from the host computer to the memory, to cause the replacement management information buffer to hold the replacement management information of a portion of the data for which the replacement has occurred.
(12)

A memory control method including:

in a case in which replacement management information for managing a relationship between a predetermined data area of a memory and a replacement area corresponding to the data area is stored in the memory,

a procedure in which, in a case in which replacement has not occurred in the memory for data related to an access command from a host computer to the memory, a memory controller performs control such that access is made to the memory using an address of the access command; and

a procedure in which, in a case in which the replacement has occurred for the data related to the access command, the memory controller performs control such that a replacement management information buffer of the memory controller is caused to hold the replacement management information of a portion of the data for which the replacement has occurred, the address of the access command is converted into an address of the replacement area in accordance with the replacement management information held by the replacement management information buffer, and access is made to the memory using a result of the conversion.
(13)

A program causing a computer of a memory controller to execute:

in a case in which replacement management information for managing a relationship between a predetermined data area of a memory and a replacement area corresponding to the data area is stored in the memory,

a control procedure in which, in a case in which replacement has not occurred in the memory for data related to an access command from a host computer to the memory, access is made to the memory using an address of the access command; and

a control procedure in which, in a case in which the replacement has occurred for the data related to the access command, a replacement management information buffer of the memory controller is caused to hold the replacement management information of a portion of the data for which the replacement has occurred, the address of the access command is converted into an address of the replacement area in accordance with the replacement management information held by the replacement management information buffer, and access is made to the memory using a result of the conversion.

### REFERENCE SIGNS LIST

100 host computer
102 controller interface
110 processing unit
200 memory controller
201 host interface
203 memory interface
210 memory control unit
211 control unit
212 replacement processing unit
220 data buffer
230 replacement occurrence flag information buffer
240 replacement management information buffer
250 address comparison unit
251 comparator
252 page address generation unit
300 memory
302 controller interface
310 control unit
330 memory cell array
331 data page area
332 replacement page area

1. A memory controller comprising:
a replacement management information buffer configured to hold part of replacement management information for managing a relationship between a predetermined data area of a memory and a replacement area corresponding to the data area in a case in which the replacement management information is stored in the memory; and
a replacement processing unit configured, in a case in which replacement has occurred in the memory for data related to an access command from a host computer to the memory, to cause the replacement management information buffer to hold the replacement management information of a portion of the data for which the replacement has occurred.

2. The memory controller according to claim 1, wherein the replacement processing unit performs control such that access is made to the memory using an address of the access command in a case in which the replacement has not occurred for the data related to the access command, and performs control such that access is made to the memory using a result obtained by converting the address of the access command into an address of the replacement area in accordance with the replacement management information held by the replacement management information buffer in a case in which the replacement has occurred for the data related to the access command.

3. The memory controller according to claim 1, wherein the replacement management information buffer holds, in each data area, an address of the replacement area in the memory which corresponds to the data area.

4. The memory controller according to claim 1, wherein the replacement management information buffer holds, in each replacement area, an address of the data area in the memory which corresponds to the replacement area.

5. The memory controller according to claim 4, further comprising:
a comparison unit configured to generate an address of the replacement area by comparing an address related to the access command with an address held by the replacement management information buffer.

6. The memory controller according to claim 1,
wherein the replacement management information manages a relationship between the data area and the replacement area corresponding to the data area in a unit of a page of the memory, and
the replacement processing unit determines occurrence or non-occurrence of the replacement in a unit of a section including a plurality of the pages.

7. The memory controller according to claim 6, further comprising:
a replacement occurrence flag information buffer configured to hold replacement occurrence flag information representing occurrence or non-occurrence of the replacement for each section.

8. The memory controller according to claim 6, wherein the replacement management information buffer holds the replacement management information related to the plurality of sections.

9. The memory controller according to claim 6, wherein the replacement management information buffer holds the replacement management information with the plurality of consecutive sections as a management unit.

10. A memory system comprising:
a memory;
a replacement management information buffer configured to hold part of replacement management information for managing a relationship between a predetermined data area of the memory and a replacement area corresponding to the data area in a case in which the replacement management information is stored in the memory; and
a replacement processing unit configured, in a case in which replacement has occurred in the memory for data related to an access command from a host computer to the memory, to cause the replacement management information buffer to hold the replacement management information of a portion of the data for which the replacement has occurred.

11. An information processing system comprising:
a memory;
a host computer configured to issue an access command to the memory;
a replacement management information buffer configured to hold part of replacement management information for managing a relationship between a predetermined data area of the memory and a replacement area corresponding to the data area in a case in which the replacement management information is stored in the memory; and
a replacement processing unit configured, in a case in which replacement has occurred in the memory for data related to an access command from the host computer to the memory, to cause the replacement management information buffer to hold the replacement management information of a portion of the data for which the replacement has occurred.

12. A memory control method comprising:
in a case in which replacement management information for managing a relationship between a predetermined data area of a memory and a replacement area corresponding to the data area is stored in the memory,
a procedure in which, in a case in which replacement has not occurred in the memory for data related to an access command from a host computer to the memory, a memory controller performs control such that access is made to the memory using an address of the access command; and
a procedure in which, in a case in which the replacement has occurred for the data related to the access command, the memory controller performs control such that a replacement management information buffer of the memory controller is caused to hold the replacement management information of a portion of the data for which the replacement has occurred, the address of the access command is converted into an address of the replacement area in accordance with the replacement management information held by the replacement management information buffer, and access is made to the memory using a result of the conversion.

13. A program causing a computer of a memory controller to execute:
in a case in which replacement management information for managing a relationship between a predetermined data area of a memory and a replacement area corresponding to the data area is stored in the memory,
a control procedure in which, in a case in which replacement has not occurred in the memory for data related to an access command from a host computer to the memory, access is made to the memory using an address of the access command; and
a control procedure in which, in a case in which the replacement has occurred for the data related to the access command, a replacement management information buffer of the memory controller is caused to hold the replacement management information of a portion of the data for which the replacement has occurred, the address of the access command is converted into an address of the replacement area in accordance with the replacement management information held by the replacement management information buffer, and access is made to the memory using a result of the conversion.
